(19) United States
(12) Patent Application Publication
(10) Pub. No.: US 2022/0081533 A1
(43) Pub. Date: Mar. 17, 2022

(54) ANTIOXIDANT BLEND FOR EMULSION POLYMERISATION RUBBERS

(71) Applicant: SI GROUP USA (USAA), LLC, Danbury, CT (US)

(72) Inventors: Jiong YU, Congers, NY (US); Jonathan HILL, Flixton, Greater Manchester (GB); Joey ZHOU, Shanghai (CN)

(21) Appl. No.: 17/612,872

(22) PCT Filed: May 22, 2020
(86) PCT No.: PCT/US2020/034224

§ 371 Date: Nov. 19, 2021

(30) Foreign Application Priority Data
May 24, 2019 (GB) 1907363.4

(51) Int. Cl. C08K 5/00; C08K 5/524; C08K 5/18; C08K 5/13; C08K 5/36; C08F 36/06; C08F 2/22

(52) U.S. Cl. CPC C08K 5/005; C08K 5/524; C08K 5/18; C08K 5/13; C08L 9/06; C08F 36/06; C08F 2/22; C08L 2201/08; C08K 2201/019; C08K 5/36

(57) ABSTRACT

The present invention relates to stabilising compositions, particularly stabilising compositions which can be used to stabilise elastomeric materials, such as rubbers and/or butadiene based elastomers. The stabilising composition comprises: a first stabilising component comprising at least one phosphite antioxidant; a second stabilising component comprising at least one aminic antioxidant; and a third stabilising component comprising at least one phenolic antioxidant. Also disclosed herein is use of the stabilising composition for stabilising elastomeric materials, a stabilised composition comprising an elastomeric material and the aforementioned stabilising composition and a useful article comprising the stabilising composition.

This application claims priority to United Kingdom Patent Application No. GB1907363.4, filed on May 24, 2019, which is herein incorporated by reference in its entirety.

The present invention relates to stabilising compositions. More particularly, but not exclusively, the present invention relates to stabilising compositions useful for stabilising polymers, particularly the stabilisation of elastomers, such as rubbers and/or butadiene based elastomers.

Polymers are used in a wide variety of applications. Elastomers are a class of polymer with a range of structures, properties and applications. They all exhibit a degree of viscoelasticity and can be made with natural or synthetic polymers. Elastomers are used in a wide variety of applications such as tyres, tubes, gaskets and seals, due to their unique properties such as high elasticity, durability and high strength.

Elastomers are susceptible to both physical and visual degradation over time which results in inferior performance and reduced service life. Factors such as exposure to heat, oxygen, ozone and radiation (for example light) can cause elastomers to degrade and lead to substantial changes in their mechanical properties; for example, as a result of softening or hardening of the elastomer. The viscosity of rubbers can therefore vary substantially with degradation. Most commonly, elastomeric structures degrade by chain scission and/or crosslinking. Undesirable odours, discolouration and colour fading of elastomers can also be observed as a result of degradation.

Polybutadiene and its copolymers that contain fewer active double bonds are more predominantly affected by degradation as a result of chain crosslinking. Elastomers with bulkier groups or electron donating groups such as natural rubber, polyisoprene and isobutylene isoprene rubber are more susceptible to degradation via chain scission.

Mooney viscosity values are widely used to estimate the ability of elastomers to flow and retain shape. It is important to ensure that Mooney viscosity values do not drift and fluctuate over prolonged periods of time to ensure that elastomeric properties are maintained.

Therefore, it is important to maintain Mooney viscosity in elastomeric materials to minimise the degrading effect of chain scission and/or crosslinking. Discolouration of elastomers can also be observed as a result of degradation; therefore, it is important to also minimise colour change.

For many elastomeric applications, it is desirable for the elastomer to retain certain properties during storage, handling and subsequent application. More specifically, it is desirable for an elastomer to retain its melt flow properties, Mooney viscosity and have good colour stability during storage, and even during prolonged or repeated exposure to temperature fluctuations during storage.

To aid retention of elastomeric properties such as Mooney viscosity (ML (1+4) at 100° C.) and colour stability (according to Yellowness Index), it is known to add different types of additives to an elastomer, in particular, it is known to add antioxidants.

U.S. Pat. No. 9,309,379 describes a composition comprising an emulsion crude rubber, synthetic latex or natural rubber latex subject to degradation and, a stabiliser comprising a mixture selected from a specific group of the alkylthiomethylphenol type compounds and styrenated diphenylamines.

U.S. Pat. No. 4,489,099 describes a chewing gum rubber composition (gum base) that utilises as an antioxidant stabiliser system a combination of dilauryl thiodipropionate and at least one member selected from the group consisting of t-butyl-hydroquinone (TBHQ), and Vitamin E.

EP2980146 describes an elastomer compositing comprising a diene-based elastomer containing an antioxidant. The antioxidant comprises a combination of tris(nonyl phenyl) phosphite (TNPP) and tetramethylethylene diamine (TMEDA) in a weight ratio of TNPP to TMEDA in a range of from 4/1 to 50/1. Also, a rubber composition comprising such an elastomer composite, an article of manufacture such as a tyre comprising such an elastomer composite or rubber composition as well as methods of manufacturing are disclosed.

EP2159264 describes an acrylic rubber composition and a vulcanized rubber that ensure heat resistance of the vulcanized rubber, especially less changes in the elongation at break (EB) and hardness of the vulcanized rubber under heating conditions. An acrylic rubber composition comprising a carboxyl group-containing acrylic rubber and, per 100 parts by mass of the carboxyl group-containing acrylic rubber, from 10 to 100 parts by mass of carbon black, from 0.1 to 15 parts by mass of at least one primary antioxidant selected from the group consisting of an amine antioxidant and a phenolic antioxidant and from 0.1 to 15 parts by mass of at least one secondary antioxidant selected from the group consisting of a phosphorus antioxidant and a sulphur antioxidant.

WO2015114131 discusses compositions useful for stabilising organic polymers, especially natural or synthetic rubbers against oxidative degradation and spoilage, comprising a) poly (dicyclopentadiene-co-p-cresol) (Formula I); b) a sterically hindered phenol of Formula II; and c) an alkyl thio phenol of Formula III.

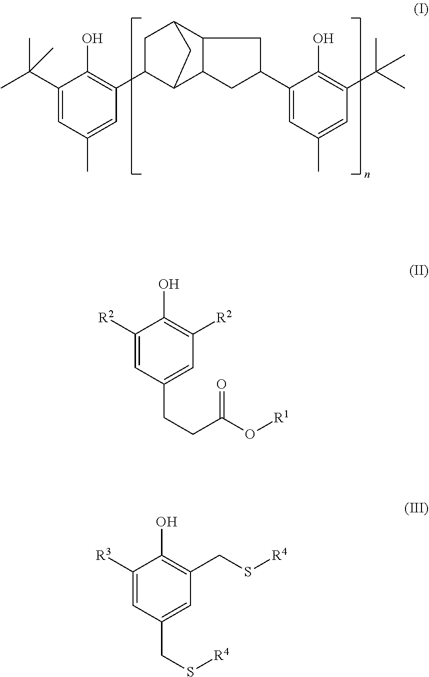

WO2018041649 describes a liquid antioxidant composition used for raw rubbers, comprising: a) 5% to 30% by weight of at least one aromatic amine-based antioxidant agent; b) 20% to 70% by weight of at least one hindered phenol-based antioxidant agent; c) 0% to 40% by weight of at least one phosphite-based antioxidant agent; and d) 20% to 40% by weight of at least one solvent having a boiling point higher than 185° C. and freezing point lower than −10° C. under 101.325 kPa, the weight percentage of component a), b), c) or d) is based on the total weight of antioxidant composition, wherein the mixture of component a), b) and c) is liquid at 25° C. under 101.325 kPa.

WO2007050991 describes a composition comprising: an antioxidant; and at least one additive selected from the group consisting of: a phosphorus stabiliser, an acid stabiliser, and a co-stabiliser.

GB2322374 describes a composition comprising: an organic material which is subject to oxidative, thermal or light-induced degradation; at least one compound of the benzofuran-2-one type; at least one compound from the group of the organic phosphites or phosphonites; at least one compound from the group of the phenolic antioxidants; and at least one compound from the group of the sterically hindered amines.

JP2018070747 describes a polyolefin resin material stabilised with a phenolic antioxidant, a phosphorus-based antioxidant and a hindered amine light stabiliser.

JP2003012900 describes a composition comprising an aromatic amine-based antioxidant, a hindered phenolic antioxidant, a sulphur-based antioxidant and a phosphorus-based antioxidant.

US20070254990 describes a pipe coating resin composition having an oxidative induction time in excess of five minutes, wherein said composition comprises: a thermoplastic ethylene-alpha olefin copolymer composition having a melt index as determined by ASTM D1238 of from 1 to 10 grams/10 minutes and a molecular weight distribution of from 2.0 to 3.0; and an antioxidant system comprising from 250 to 2500 ppm of a hindered phenolic, a secondary antioxidant which is a phosphorus (III) compound and a hindered amine light stabiliser.

There is an ongoing need in industry for an improved stabilising composition that does not suffer from discolouration, changes in Mooney viscosity and undesirable odour, particularly when exposed to temperature fluctuations during storage for a prolonged or repeated period of time.

According to a first aspect of the present invention, there is provided a stabilising composition for an elastomer, comprising:
a. a first stabilising component comprising at least one phosphite antioxidant;
b. a second stabilising component comprising at least one aminic antioxidant; and
c. a third stabilising component comprising at least one phenolic antioxidant.

The inventors of the present invention have surprisingly found that a stabilising composition according to the invention results in a superior retention of properties and is highly effective at stabilising articles made using elastomers, in particular butadiene based elastomers, compared with compositions conventionally used in the art.

The elastomer may be butadiene based. In this context, by “butadiene based” it is meant that the elastomer comprises butadiene or a butadiene derivative, for example chloroprene, as a monomeric base unit. For example, the elastomer may comprise polybutadiene (BR), nitrile rubber (NBR), styrene-butadiene (SBR), polychloroprene (CR) and/or compatible mixtures of two or more thereof.

It has been unexpectedly found that the elastomeric material to which the stabilising composition of the present invention is added to exceeds the performance of the same elastomeric material stabilised with the industry benchmark, 4,6-bis(octylthiomethyl)-o-cresol (LOWINOX™ 520—CAS 110553-27-0), in Mooney viscosity retention, colour performance and has a lower overall odour. Thus, the stabilising composition of the present invention can be used to replace the conventional additive.

Without wishing to be bound by theory, it is believed that the antioxidants of the present invention exhibit a synergistic effect upon the composition or article that is stabilised, for example the elastomeric material and articles manufactured thereof. This synergistic blend is important in significantly improving the Mooney viscosity retention and colour retention during heat aging, as well as providing a lower initial colour.

The stabilising composition of the invention which when added to an elastomer may cause the Mooney viscosity of the elastomer (measured in accordance with ASTM D1646) to fluctuate less over a six day heat aging period at 100° C. than that of the same elastomer to which an equivalent w/w amount of the same stabilising composition absent any aminic component has been added.

This accelerated heat aging test uses an increased temperature (100° C.) to simulate several months at various storage and transportation conditions. It is a widely accepted standard quality control test for elastomers. This accelerated heat aging test is used to predict the long-term heat and storage stability of the elastomer.

The maximum % fluctuation (measured as the % difference between the starting Mooney viscosity and the highest and/or lowest measured Mooney viscosity) may result in the viscosity of the elastomer (measured in accordance with ASTM D1646) to fluctuate by less than 30%, less than 25%, less than 20%, less than 16% or less than 10% over a six day period.

The stabilising composition of the invention which when added to an elastomer may cause the initial Yellowness Index value (day 0) of the elastomer (measured in accordance with ASTM E313) to be less than about 15, less than about 10, less than about 8.

The stabilising composition of the invention which when added to an elastomer may cause the Yellowness Index value of the elastomer (measured in accordance with ASTM E313) to be less than 45, less than 40, less than 37, less than 35, less than 30, after a period of four days.

In the following paragraphs, compounds designated by the tradenames AMINOX™, ANOX™, BLE™, DURAZONE™, FLEXZONE™, LOWINOX™ NAUGALUBE™, NAUGARD™, NAUGAWHITE™, NOVAZONE™, OCTAMINE™, WESTON™ are available from SI Group USA (USAA), LLC, 4 Mountainview Terrace, Suite 200, Danbury, Conn. 06810.

The phosphite antioxidant may be a liquid at ambient conditions. The aminic antioxidant may be a liquid at ambient conditions. Preferably, both the phosphite antioxidant and aminic antioxidant are liquid at ambient conditions. However, in some cases it is possible to create a stabilising composition according to the invention which is liquid at ambient conditions by blending a liquid phosphite antioxidant with a solid aminic antioxidant.

It may also be possible to create a stabilising composition according to the invention which is liquid at ambient conditions by blending a solid phosphite antioxidant with a liquid aminic antioxidant.

By “ambient conditions” we mean preferably a temperature of 50° C. or lower, more preferably a temperature of 30° C. or lower and most preferably a temperature of 25° C. or lower, and atmospheric pressure i.e. 101.325 kPa. For example, “ambient conditions” may mean a temperature of 25° C. and atmospheric pressure.

Preferably, the stabilising composition is a liquid at ambient conditions.

The phosphite antioxidants provided in the stabilising composition of the invention are selected such that the stabilising composition is liquid at ambient conditions, as described above. Often this will be achieved by selecting individual phosphite antioxidant components which are themselves liquid at ambient conditions.

The phosphite antioxidant may comprise an organophosphite antioxidant.

The phosphite antioxidant may comprise a triaryl phosphite, a trialkyl phosphite and/or an alkyl-aryl phosphite.

The phosphite antioxidant may comprise a triaryl phosphite, optionally a triphenyl phosphite.

The phosphite antioxidant may comprise one or more triaryl phosphites of Formula I:

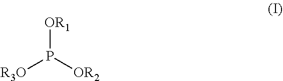

wherein R₁, R₂ and R₃ are independently selected alkylated aryl groups of Formula II:

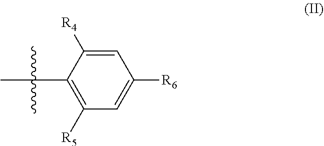

wherein R₄, R₅ and R₆ are independently selected from the group consisting of hydrogen and C₁ to C₂₀ alkyl, provided that at least one of R₄, R₅ and R₆ is not hydrogen.

R₄, R₅ and R₆ may be independently selected from the group consisting of hydrogen and C₁ to C₁₀ alkyl, provided that at least one of R₄, R₅ and R₆ is not hydrogen.

R₄, R₅ and R₆ may be independently selected from the group consisting of hydrogen and C₁ to C₆ alkyl, provided that at least one of R₄, R₅ and R₆ is not hydrogen.

The C₁ to C₆ alkyl may be selected from methyl, ethyl, propyl, butyl, pentyl, hexyl and/or isomers thereof, for example isopropyl, isobutyl, sec-butyl, tert-butyl, isopentyl, tert-pentyl and/or neopentyl.

At least one of R₄, R₅ and R₆ may be selected from the group consisting of tert-butyl and/or tert-pentyl.

The one or more triaryl phosphites may have the structure of Formula (III):

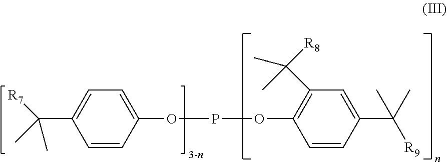

wherein R₇, R₈ and R₉ are independently selected from methyl and ethyl groups, and wherein n is 0, 1, 2 or 3.

The one or more triaryl phosphites may be independently selected from the group consisting of tris(4-tert-butylphenyl) phosphite; tris(2,4-di-tert-butylphenyl) phosphite; bis(4-tert-butylphenyl)-2,4-di-tert-butylphenyl phosphite; bis(2,4-di-tert-butylphenyl)-4-tert-butylphenyl phosphite; tris(4-tert-pentylphenyl) phosphite; tris(2,4-di-tert-pentylphenyl) phosphite; bis(4-tert-pentylphenyl)-2,4-di-tert-pentylphenyl phosphite; bis(2,4-di-tert-pentylphenyl)-4-tert-pentylphenyl phosphite; and/or blends thereof.

The one or more triaryl phosphites may be independently selected from the group consisting of tris(4-tert-pentylphenyl) phosphite; tris(2,4-di-tert-pentylphenyl) phosphite; bis(4-tert-pentylphenyl)-2,4-di-tert-pentylphenyl phosphite; bis(2,4-di-tert-pentylphenyl)-4-tert-pentylphenyl phosphite; and/or blends thereof.

The phosphite antioxidant may comprise a blend of triaryl phosphites as previously described. Preferably, the phosphite antioxidant comprises a blend of at least two different triaryl phosphites, at least three different triaryl phosphites or at least four different triaryl phosphites.

A particularly preferred phosphite antioxidant according to the invention comprises mixed 2,4-bis(1,1-dimethylpropyl)phenyl and 4-(1,1-dimethylpropyl)phenyl phosphite (WESTON™ 705—CAS 939402-02-5).

The inventors of the present invention have found that certain advantages are realised when the phosphite antioxidant comprises one or more triaryl phosphites. In particular, it has been found that triaryl phosphites are much more stable and less prone to hydrolysis when combined with an elastomer and under elastomer processing conditions, compared to other known phosphite antioxidants, particularly alkyl-aryl phosphites such as tetra-C12-15-alkyl(propane-2,2-diylbis(4,1-phenylene))bis(phosphite) (CAS 96152-48-6). In WO2018041649 a crucial component of the antioxidant composition is the solvent, which is used to ensure that the antioxidants, especially the phosphite antioxidant, do not hydrolyse during production of the raw rubber. Conversely, the stabilising composition of the present invention is stable under elastomer processing conditions and can therefore be formulated in the absence of any solvent.

The phosphite antioxidant may be a nonyl phenyl free antioxidant.

The phosphite antioxidant may comprise a trialkyl phosphite, for example DOVERPHOS™ LGP-11 (such as is available from Dover Chemicals).

The phosphite antioxidant may comprise an alkyl-aryl phosphite, for example tris (tridecyl) phosphite (WESTON™ TTDP—CAS 25488-25-3).

By way of specific and non-limiting examples, the phosphite antioxidant may for example comprise one or more of mixed 2,4-bis(1,1-dimethylpropyl)phenyl and 4-(1,1-dimethylpropyl)phenyl phosphite (WESTON™ 705 (CAS 939402-02-5); tris (nonylphenyl) phosphite (WESTON™ TNPP—CAS 26523-78-4); tris (tridecyl) phosphite (WESTON™ TTDP—CAS 25488-25-3); tri lauryl phosphite (WESTON™ TLP—CAS 3076-63-9); tri isodecyl phosphite (WESTON™ TDP—CAS 25448-25-3); phenyl di isodecyl phosphite (WESTON™ PDDP—CAS 25550-98-5); diphenyl isodecyl phosphite (WESTON™ DPDP—CAS 26544-23-0); tri isooctyl phosphite (TOP—CAS 25103-12-52); tris(2-ethylhexyl) phosphite (CAS 78-42-2); mixed 2-ethylhexyl phenyl phosphite ester (WESTON™ EHDP—CAS 15647-8-2); tris(dipropylene glycol) phosphite (WESTON™ 430—CAS 36788-39-3); poly 4,4′ Isopropylidenediphenol C12-15 alcohol phosphite (WESTON™ 439—CAS 96152-48-6); polymeric liquid phosphite (DOVERPHOS™ LGP-11, such as is available from Dover Chemicals); 4,4′-butylidene-bis(3-methyl-6-tert-butylphenyl)alkyl(C13)-phosphite; and/or compatible mixtures of two or more thereof.

The phosphite antioxidant may comprise mixed 2,4-bis(1,1-dimethylpropyl)phenyl and 4-(1,1-dimethylpropyl)phenyl phosphite (WESTON™ 705—CAS 939402-02-5) and/or tris (tridecyl) phosphite (WESTON™ TTDP—CAS 25488-25-3).

The phosphite antioxidant may comprise mixed 2,4-bis(1,1-dimethylpropyl)phenyl and 4-(1,1-dimethylpropyl)phenyl phosphite (WESTON™ 705—CAS 939402-02-5).

The phosphite antioxidant may be present in an amount of from about 20% to about 95% by weight of the stabilising composition, from about 25% to about 90% by weight of the stabilising composition, from about 30% to about 85% by weight of the stabilising composition, from about 35% to about 70% by weight of the stabilising composition, or from about 50% to about 65% by weight of the stabilising composition.

Preferably, the phosphite antioxidant is present in an amount greater than about 40% by weight of the stabilising composition. For example, the phosphite antioxidant may be present in an amount greater than about 40% up to an amount of about 60%, about 65%, about 70%, about 75%, about 80%, about 85%, about 90% or about 95% by weight of the stabilising composition.

The phosphite antioxidant may be present in an amount of from about 41%, about 42%, about 45%, or about 50%, to about 60%, about 65%, about 70%, about 75%, about 80%, about 85%, about 90%, or about 95% by weight of the stabilising composition. For example, the phosphite may be present in an amount of from about 42% to about 75% by weight of the stabilising composition, from about 45% to about 70% by weight of the stabilising composition, or from about 50% to about 65% by weight of the stabilising composition.

The phosphite antioxidant may be a liquid at a temperature of 50° C. or lower, optionally 30° C. or lower, optionally 25° C. or lower, at atmospheric pressure i.e. 101.325 kPa. The phosphite antioxidant may be a liquid at a temperature of 25° C. and atmospheric pressure i.e. 101.325 kPa.

Stabilising component (b) comprises one or more aminic antioxidants.

By way of specific and non-limiting examples, the aminic antioxidant may for example comprise 4,4′-bis(α,α-dimethylbenzyl) diphenylamine (NAUGARD™ 445—CAS 10081-67-1); mixed butylated, octylated diphenylamine (NAUGARD™ PS30—CAS 68411-46-1); octylated diphenylamine (OCTAMINE™—CAS 101-67-7); nonylated diphenylamine (NAUGALUBE™ 438L—CAS 122-39-4); polymerised 1,2-dihydro-2,2,4-trimethylquinoline (NAUGARD™ Q—CAS 26780-96-1); N,N-bis-(1,4-dimethylpentyl)-p-phenylenediamine (FLEXZONE™ 4L—CAS 3081-14-9); acetone diphenylamine (AMINOX™—CAS 68412-48-6); reaction products of diphenylamine and acetone (BLE™—CAS 112-39-4); 1,4-benzenediamine, N,N′-mixed phenyl and tolyl derivatives (NOVAZONE™ AS—CAS 68953-84-4); benzamine, N-phenyl-, reaction products with 2,4,4-trimethylpentene (IRGANOX™ 5057—CAS 68411-46-1 (such as is available from BASF)); N-(1,3-dimethylbutyl)-N-phenyl-p-phenylenediamine (SANTOFLEX™ 6PPD—CAS 793-24-8 (such as is available from Eastman)); N,N′-diphenyl-p-phenylendiamine (DPPD—CAS 74-31-7); N-isopropyl-N′-phenyl-1,4-phenylenediamine (IPPD—CAS 101-72-4); 2,4,6-Tris-(N-1,4-dimethylpentyl-p-phenylenediamino)-1,3,5-triazine (DURAZONE™ 37—CAS 121246-28-4); N,N′-Bis(1,4-dimethylpentyl)-p-phenylenediamine (SANTOFLEX™ 77PD—CAS 3081-14-9 (such as is available from Eastman); and/or compatible mixtures of two or more thereof.

The aminic antioxidant may comprise 4,4′-bis(α,α-dimethylbenzyl) diphenylamine (NAUGARD™ 445—CAS 10081-67-1) and/or mixed butylated, octylated diphenylamine (NAUGARD™ PS30—CAS 68411-46-1).

The amine antioxidant may comprise mixed butylated, octylated diphenylamine (NAUGARD™ PS30—CAS 68411-46-1).

Mixed butylated, octylated diphenylamine (NAUGARD™ PS30—CAS 68411-46-1) is a liquid aminic antioxidant that in particular facilitates the creation of a liquid blend according to the present invention.

The aminic antioxidant may be present in an amount from about 1% to about 40% by weight of the stabilising composition, from about 1% to about 30% by weight of the stabilising composition, from about 5% to about 25% by weight of the stabilising composition, or from about 7% to about 20% by weight of the stabilising composition.

The aminic antioxidant may be a secondary amine.

The aminic antioxidant may be an aromatic amine.

The aminic antioxidant may have the general formula —R—NH—R′, optionally wherein the R and/or the R′ group is aromatic. R and R′ may be the same or different.

The aminic antioxidant may have the general formula R—NH—R′—NH—R, optionally wherein the R′ is aromatic and/or the R group is an aromatic and/or alkyl. R and R′ may be the same or different.

The aminic antioxidant may comprise at least one aromatic group, or at least two aromatic groups.

The aminic antioxidant may comprise a single compound or a blend of two or more compounds.

The aminic antioxidant may have an overall nitrogen content of at least 3.5%, or at least 4% w/w.

Stabilising component (c) comprises one or more phenolic antioxidants.

The phenolic antioxidant may comprise a single compound or a blend of two or more compounds.

The phenolic antioxidant may be optionally substituted.

The phenolic antioxidant may comprise a semi-hindered and/or a hindered phenolic antioxidant.

The phenolic antioxidant may comprise a hindered phenolic antioxidant.

In this specification by “hindered” we preferably mean that the phenolic antioxidant comprises substituent hydrocarbyl groups on both positions ortho to the phenolic —OH group, each of those substituent groups being branched at the C₁ and/or C₂ position, preferably at the C₁ position, with respect to the aromatic ring.

In this specification by “semi-hindered” we preferably mean that the phenolic antioxidant comprises at least one substituent hydrocarbyl group ortho to the phenolic —OH group, only one of the substituent group or each substituent group being branched at the C₁ and/or C₂ position, preferably at the C₁ position, with respect to the aromatic ring.

The phenolic antioxidant may comprise a phenol group which is substituted, preferably substituted twice, preferably in that case at positions ortho to the —OH group in the phenol.

The or each substituent on the phenol group may comprise an alkyl group, optionally a branched chain alkyl group, optionally t-butyl.

The phenolic antioxidant may be further substituted at the positions meta and para to the —OH group in the phenol.

The phenolic antioxidant may comprise a plurality of phenol groups.

By way of specific and non-limiting examples, the phenolic antioxidant may comprise: C13-C15 linear and branched alkyl esters of 3-(3′,5′-di-t-butyl-4-hydroxyphenyl)propionate (ANOX™ 1315—CAS 171090-93-0); octadecyl 3-(3′,5′-di-t-butyl-4-hydroxyphenyl)propionate (ANOX™ PP18—CAS 2082-79-3); isooctyl 3-(3′,5′-di-t-butyl-4-hydroxyphenyl)propionate (NAUGARD™ PS48—CAS 125643-61-0); methyl 3-(3′,5′-di-t-butyl-4-hydroxyphenyl) propionate (CAS 6386-38-5); pentaerythritol tetrakis (3-(3,5-di-tert.butyl-4-hydroxyphenyl)propionate (ANOX™ 20—CAS 6683-19-8); butylated hydroxytoluene (BHT—CAS 128-37-0); butylated hydroxy ethylbenzene (BHEB—CAS 4130-42-1); butylated octylated phenol (ANOX™ T—CAS 12674-05-4); styrenated phenol (NAUGARD™ SP—CAS 61788-44-1); styrenated p-cresol (NAUGARD™ 431—CAS 1817-68-1); benzene propanoic acid, 3,5-bis(1,1-dimethyl-ethyl)-4-hydroxy-C7-C9 branched alkyl esters (IRGANOX™ 1135—CAS 125643-61-0 (such as is available from BASF)); 2,2-Methylenebis (6-nonyl-p-cresol) (NAUGAWHITE™—CAS 7786-17-6); 4-sec-butyl-2,6-di-tert-butylphenol (CAS 17540-75-9); 2-tert-butyl-4,6-dimethylphenol (LOWINOX™ 624—CAS 1879-09-0); mixed tert-butylated phenols (ISONOX™133—CAS 60083-44-5 (such as is available from available from SI Group Inc. of 2750 Balltown Road, Schenectady, N.Y. 12301, US)); 4,4′-methylenebis(2,6-di-tert-butylphenol) (CAS 118-82-1); methyl 3-(3,5-di-tert-butyl-4-hydroxyphenyl)propionate (PP base—CAS 6386-38-5); 2,4-dimethyl-6-(1-methylpentadecyl)-phenol (CAS 134701-20-5); and/or compatible mixtures of two or more thereof.

The phenolic antioxidant may comprise C13-C15 linear and branched alkyl esters of 3-(3′,5′-di-t-butyl-4-hydroxyphenyl)propionate (ANOX™ 1315—CAS 171090-93-0) and/or isooctyl 3-(3′,5′-di-t-butyl-4-hydroxyphenyl)propionate (NAUGARD™ PS48—CAS 125643-61-0).

The phenolic antioxidant may be present in an amount from about 5% to about 70% by weight of the stabilising composition, from about 10% to about 60% by weight of the stabilising composition, from about 15% to about 55% by weight of the stabilising composition, from about 20% to about 50% by weight of the stabilising composition, or from about 20% to about 40% by weight of the stabilising composition.

The phenolic antioxidant may be selected to be a liquid at a temperature of 50° C. or lower, optionally 30° C. or lower, optionally 25° C. or lower, at atmospheric pressure i.e. 101.325 kPa. The phenolic antioxidant may be a liquid at a temperature of 25° C. at atmospheric pressure i.e. 101.325 kPa.

The ratio of phosphite antioxidant to aminic antioxidant to phenolic antioxidant in the stabilising composition may be: (from about 35 to about 70):(from about 1 to about 30):(from about 15 to about 35); (from about 45 to about 65):(from about 5 to about 25):(from about 15 to about 30); or (from about 50 to about 65):(from about 7 to about 20):(from about 20 to about 30).

Additional antioxidants, for example hydroxylamines or precursors thereof, lactone radical scavengers, acrylate radical scavengers, UV absorbers and/or chelating agents, may be included in the stabilising composition.

The stabilising composition according to the invention is particularly effective at stabilising elastomeric materials. The elastomeric material may be stabilised against, for example, oxidative, thermal and/or radiation (for example light) induced degradation.

The stabilising composition in accordance with the invention may additionally comprise a fourth stabilising component comprising at least one sulphur-containing antioxidant.

For example, the stabilising composition may comprise:
a. a first stabilising component comprising at least one phosphite antioxidant;
b. a second stabilising component comprising at least one aminic antioxidant;
c. a third stabilising component comprising at least one phenolic antioxidant; optionally,
d. a fourth stabilising component comprising at least one sulphur-containing antioxidant.

The sulphur-containing antioxidant may comprise one or more thioether groups.

The sulphur-containing antioxidant may comprise one or more thioester groups.

The sulphur-containing antioxidant may comprise a sulphur-containing phenolic antioxidant.

The sulphur-containing antioxidant may be a liquid at ambient conditions.

By way of specific and non-limiting examples, the sulphur-containing antioxidant may comprise: 4,6-bis(octylthiomethyl)-o-cresol (LOWINOX™ 520—CAS 110553-27-0); 2,2′thiodiethylene bis[3(3,5-di-t-butyl-4-hydroxyphenyl)propionate] (ANOX™ 70—CAS 41484-35-9); dilauryl thiodipropionate (NAUGARD™ DLTDP—CAS 123-28-4); distearyl thiodipropionate (NAUGARD™ DSTSP—CAS 693-36-7); ditridecylthiodipropionate (NAUGARD™ DTDTDP—CAS 10595-72-9); pentaerythritol tetrakis (β-laurylthiopropionate) (NAUGARD™ 412S—CAS 29598-76-3); 2,4-Bis(dodecylthiomethyl)-6-methylphenol (IRGANOX™ 1726—CAS 110675-26-8 (such as is available from BASF)); and/or compatible mixtures of two or more thereof.

The sulphur-containing antioxidant may comprise 4,6-bis(octylthiomethyl)-o-cresol (LOWINOX™ 520—CAS 110553-27-0) and/or ditridecylthiodipropionate (NAUGARD™ DTDTDP—CAS 10595-72-9).

The sulphur-containing antioxidant may be present in an amount from about 0% to about 50% by weight of the stabilising composition, from about 1% to about 40% by weight of the stabilising composition, from about 2% to about 30% by weight of the stabilising composition, from about 2% to about 20% by weight of the stabilising composition, or from about 2% to about 10% by weight of the stabilising composition.

The ratio of phosphite antioxidant to aminic antioxidant to phenolic antioxidant to sulphur-containing antioxidant in the stabilising composition may be: (from about 35 to about 70):(from about 1 to about 30):(from about 15 to about 35):(from about 0 to about 20); (from about 45 to about 65):(from about 5 to about 25):(from about 15 to about 30):(from about 1 to about 15); or (from about 50 to about 65):(from about 7 to about 20):(from about 20 to about 30):(from about 1 to about 5).

According to a second aspect of the present invention, there is provided the use of the stabilising composition for stabilising elastomeric materials.

Elastomers are amorphous polymers that have a glass transition temperature below ambient temperature, preferably below usage temperature. Due to their low glass transition temperature, elastomers have excellent viscoelastic properties like high elasticity, superior impact resistance etc.

Elastomers can be thermoplastic or thermoset, vulcanized or not vulcanized.

Elastomeric materials may include natural rubber, synthetic rubber, and/or a blend of plastics with elastomers such as high impact polystyrene (HIPS) or acrylonitrile butadiene styrene (ABS).

The elastomer may be butadiene based. As outlined above, in this context, by “butadiene based” it is meant that the elastomer comprises butadiene or a butadiene derivative, for example chloroprene, as a monomeric base unit. For example, the elastomer may comprise polybutadiene (BR), nitrile rubber (NBR), styrene-butadiene (SBR), polychloroprene (CR) and/or compatible mixtures of two or more thereof.

According to a third aspect of the present invention, there is provided a stabilised elastomeric composition, comprising:
a. an elastomeric material
b. a stabilising composition according to the invention.

The stabilised elastomeric composition may be suitable for stabilising elastomeric materials, such as rubber.

The rubber may comprise natural rubber, synthetic rubber, and/or combinations thereof.

The elastomeric material may be a product of emulsion or solution polymerisation.

The elastomeric material may or may not be cross-linked after incorporation of above stabilisation in final usage.

The stabilised elastomeric composition may further comprise any material suitable for combination with the elastomeric material and stabilising composition of the invention.

By way of specific and non-limiting examples, the elastomer may comprise natural polyisoprene (cis-1,4-polyisoprene, natural rubber (NR)); gutta-percha (trans-1,4-polyisoprene); synthetic polyisoprene; polybutadiene (butadiene rubber (BR)); polychloroprene (CR); butyl rubber (copolymer of isobutylene and isoprene, IIR); halogenated butyl rubbers; styrene-butadiene (copolymer of styrene and butadiene, SBR), nitrile rubber (Buna-N rubber (NBR)); hydrogenated nitrile rubbers (HNBR) and/or compatible mixtures of two or more thereof.

The elastomer may be from emulsion polymerisation comprising at least one of styrene-butadiene (SBR); nitrile rubber (NBR); polybutadiene (BR); polychloroprene (CR).

The elastomer may comprise butadiene as one of the building blocks. Other suitable building block comonomers may be styrene, acrylonitrile, ethylene or propylene.

The elastomer may use different catalyst system, including metallocene.

The invention also concerns a useful article comprising the stabilised elastomeric composition described herein.

The stabilising composition according to the invention may be added to the elastomeric material in an amount of from about 0.01 to about 5% w/w, from about 0.05 to 3% w/w, from about 0.1 to about 2% w/w, or from about 0.2 to about 1% w/w.

This percentage of stabilising composition is important in providing the needed protection for the stabilised elastomeric composition during storage and transportation. Storage stable compositions requires Mooney viscosity changes to be as little as possible over a prolonged period of storage times, for example storage at 40° C. for up to one year.

The stabilising composition may be added during or after polymerisation.

Preferably, the stabilising composition is added after polymerisation.

According to a fourth aspect of the present invention, there is provided a process for stabilising an article made using elastomeric materials, comprising, incorporating or applying the stabilising composition of the invention to an elastomeric material.

For avoidance of doubt, all features relating to the stabilising composition of the present invention also relate, where appropriate, to the stabilised elastomeric composition, the stabilised article, and the process of stabilising an article, and vice versa.

The invention will now be more specifically described with reference to the following non-limiting examples.

### EXAMPLES

Table 1 outlines details relating to different stabilising components that were used in the stabilising compositions. Hereinafter, the stabilising components will simply be referred to using the name given in the ‘shorthand’ column.

TABLE 1

| Shorthand | CAS No. | Description | Type |
|---|---|---|---|
| W705 | 939402-02-5 | WESTON ™ 705 - mixed 2,4- | Component A |
| | | bis(1,1-dimethylpropyl)phenyl and | |
| | | 4-(1,1-dimethylpropyl)phenyl | |
| | | phosphite | |
| WTNPP | 26523-78-4 | WESTON ™ TNPP - tris | Component A |
| | | (nonylphenyl) phosphite | |
| N445 | 10081-67-1 | NAUGARD ™ 445 - 4,4′-bis(α,α- | Component B |
| | | dimethylbenzyl) diphenylamine | |
| NPS30 | 68411-46-1 | NAUGARD ™ PS30 - mixed | Component B |
| | | butylated, octylated diphenylamine | |
| 5057 | 68411-46-1 | IRGANOX ™ 5057 - benzamine, N- | Component B |
| | | phenyl-, reaction products with | |
| | | 2,4,4-trimethylpentene | |
| 438L | 122-39-4 | NAUGALUBE ™ 438L - Nonylated | Component B |
| | | diphenylamine | |
| 6PPD | 793-24-8 | SANTOFLEX ™ 6PPD - N-(1,3- | Component B |
| | | dimethylbutyl)-N′-phenyl-p- | |
| | | phenylenediamine | |
| A1315 | 171090-93-0 | ANOX ™ 1315 - C13-C15 linear and | Component C |
| | | branched alkyl esters of 3-(3′,5′-di- | |
| | | t-butyl-4-hydroxyphenyl)propionate | |
| NPS48 | 125643-61-0 | NAUGARD ™ PS48 - isooctyl 3- | Component C |
| | | (3′,5′-di-t-butyl-4- | |
| | | hydroxyphenyl)propionate | |
| NSP | 61788-44-1 | NAUGARD ™ SP - styrenated | Component C |
| | | phenol | |
| 1135 | 125643-61-0 | IRGANOX ™ 1135 - benzene | Component C |
| | | propanoic acid, 3,5-bis(1,1- | |
| | | dimethyl-ethyl)-4-hydroxy-C7-C9 | |
| | | branched alkyl esters | |
| PP base | 6386-38-5 | Methyl 3-(3,5-di-tert-butyl-4- | Component C |
| | | hydroxyphenyl)propionate | |
| L520 | 110553-27-0 | LOWINOX ™ 520 - 4,6- | Component C |
| | | bis(octylthiomethyl)-o-cresol | and/or |
| | | | Component D |
| DTDTDP | 10595-72-9 | NAUGARD ™ DTDTDP | Component D |
| | | ditridecylthiodipropionate | |

Key to Table 1:
Component A phosphite antioxidant
Component B aminic antioxidant
Component C phenolic antioxidant
Component D sulphur-containing antioxidant

As will be apparent to the skilled person, certain materials (LOWINOX™ 520-CAS 110553-27-0, for example) may fall within one or more of the component categories A, B, C, D defined as necessary components of the invention. LOWINOX™ 520 therefore can be recognised as component C and/or component D according to the present invention.

Table 2 shows the various stabilising compositions that were prepared. The % amounts shown in the table are the % by weight of the overall stabilising composition, and the dosage of the stabilising composition in parts per hundred rubber (phr).

TABLE 2

| | | | | | | | | Component C | | | | | | | |
|---|---|---|---|---|---|---|---|---|---|---|---|---|---|---|---|
| | Component A | | Component B | | | | | | | | | PP | | Component D | Dosage/ |
| Ex. | W705 | WTNPP | N445 | NPS30 | 5057 | 6PPD | 438L | A1315 | PS48 | NSP | 1135 | base | L520 | DTDTDP | phr |
| A | 66.75 | | | | | | | 33.25 | | | | | | | 0.4 |
| B | 66.66 | | | | | | | 33.33 | | | | | | | 0.6 |
| C | | 50 | | | | | | | | 50 | | | | | 1.0 |
| D | | | | | | | | | | | | | 100 | | 0.4 |
| 1 | 42.5 | | 7.5 | | | | | | 50 | | | | | | 0.4 |
| 2 | 42.5 | | 7.5 | | | | | 50 | | | | | | | 0.4 |
| 3 | 42.5 | | | 7.5 | | | | 50 | | | | | | | 0.4 |
| 4 | 60 | | | 22.5 | | | | | 17.5 | | | | | | 0.4 |
| 5 | 60 | | | 7.5 | | | | | 32.5 | | | | | | 0.4 |
| 6 | 60 | | | | 20 | | | | | | 10 | | | 10 | 0.4 |
| 7 | 25 | | | | | 50 | 3.75 | | | | 10 | 11.25 | | | 0.4 |
| 8 | 50 | | | | | | 7.5 | | | | 20 | 22.5 | | | 0.4 |
| 9 | 60 | | | 13.3 | | | | | 26.7 | | | | | | 0.6 |
| 10 | 58.4 | | | 13.3 | | | | | 25 | | | | 3.3 | | 0.6 |

Examples A, B, C and D are comparative examples absent of any aminic component, with Example D representing the industrial benchmark. Examples 1 to 10 are in accordance with the invention.

### Sample Preparation

Various mixtures of antioxidants were prepared according to the compositions summarised in Table 2. The antioxidant blends (ca 60 g) for each example were melted and mixed together. The mixture was then heated to 70° C. and dosed with oleic acid and mixed together. The mixture was then slowly dosed with KOH solution (13.3% w/w) (ca 48 g) and stirred at a high speed to ensure intimate mixing and the formation of an emulsion. The mixing speed was then reduced, and ca 152 g of hot deionised water was added. The resulting antioxidant emulsions had a solid content of about 20% w/w.

The Examples show the stability that can be attained by employing various stabilisation compositions in ESBR.

The ESBR latex was dosed with the antioxidant emulsion. After stirring, the ESBR latex samples were coagulated using a standard salt-acid coagulation system. More specifically, the samples were coagulated with a 2% calcium chloride. The latex was then dropped into the 2% calcium chloride solution and the rubber was transferred into fresh water. The rubber was washed 3 times with squeezing. The rubber was then dried in a vacuum oven for 16 hours at 50° C. A HAAKE™ Internal mixer was then used at 105° C. for 2 minutes to remove any remaining water. A two-roll mill was employed to make the elastomer more uniform.

The elastomers were oven aged at 100° C. and measurements were recorded every 24 hours for the duration of 4 days (Yellowness Index) and 6 days (Mooney viscosity).

### Testing Conditions

### Colour Stability

Samples were first placed in a compression mould at 100° C. for 5 minutes and the resulting ESBR sheet was 1 mm thick. The discolouration was measured in terms of Yellowness Index (YI) using a colourimeter. Approximately 4 g of the elastomer was taken for each YI measurement. YI values were taken at 0 hours and then every 24 hours and were measured as defined in ASTM E313. An average of 5 measurements were taken. The lower the YI value, the less discolouration of the composition. The results are shown in Table 3.

TABLE 3

| | Yellowness Index (YI) | | | | |
|---|---|---|---|---|---|
| Ex. | Day 0 | Day 1 | Day 2 | Day 3 | Day 4 |
| A | 12.57 | 20.87 | 31.69 | 36.24 | 43.34 |
| B | 13.28 | 18.87 | 31.08 | 39.04 | 42.78 |
| D | 20.60 | 28.26 | 38.37 | 45.11 | 53.75 |
| 1 | 15.32 | 21.40 | 32.46 | 46.65 | 50.57 |
| 2 | 14.31 | 21.15 | 34.27 | 45.88 | 48.33 |
| 3 | 7.09 | 14.63 | 25.09 | 32.44 | 36.04 |
| 4 | 6.66 | 14.29 | 20.99 | 29.23 | 37.16 |
| 5 | 8.83 | 15.58 | 23.94 | 30.38 | 35.83 |
| 6 | 7.34 | 14.33 | 20.55 | 26.14 | 27.87 |

Stabilising compositions A and B represent comparative examples which do not utilise an aminic antioxidant. Example D represents the industry benchmark, comprising L520.

From the results, it can be seen that the ESBR samples stabilised with stabilising compositions in accordance with the present invention (Examples 1-6) show less discolouration than the industry standard.

The ESBR samples stabilised with stabilising compositions in accordance with the present invention show a lower initial yellowness index at day 0 and a lower yellowness index value at day 4.

Therefore, the ESBR samples using the stabilising composition that is in accordance with the invention provide greater colour retention, allowing longer storage without change in colour.

### Mooney Viscosity

Approximately 20 g of samples for each of the Examples were taken for Mooney viscosity testing. Mooney viscosity was measured using the standard method ASTM D1646 (1+4) T 100° C. Mooney viscosity values were taken at 0 hours and then every 24 hours.

| | Mooney Viscosity | | | | | | | |
|---|---|---|---|---|---|---|---|---|
| | | | | | | | | Max % |
| | Day | Day | Day | Day | Day | Day | Day | Fluc- |
| Ex. | 0 | 1 | 2 | 3 | 4 | 5 | 6 | tuation |
| A | 56.30 | 50.52 | 36.33 | 61.02* | 67.64 | 72.19 | 82.58 | 46.68 |
| B | 53.52 | 49.62 | 39.99 | 37.08 | 44.66* | 54.54 | 60.81 | 30.72 |
| C | 50.93 | 37.03 | 62.09* | 64.50 | 76.22 | 73.42 | — | 49.66 |
| D | 52.98 | 42.76 | 36.01 | 31.04 | 37.51* | 42.32 | 50.50 | 41.41 |
| 1 | 53.22 | 52.37 | 46.44 | 42.26 | 41.41 | 42.98* | 43.76 | 22.19 |
| 2 | 52.03 | 53.08 | 48.17 | 44.78 | 46.29* | 44.02 | 53.17 | 15.39 |
| 3 | 48.06 | 51.21 | 50.51 | 48.60 | 46.94 | 46.85 | 48.45 | 6.55 |
| 4 | 49.08 | 52.60 | 50.51 | 48.60 | 46.94 | 46.85 | 48.45 | 7.17 |
| 5 | 49.52 | 50.69 | 46.59 | 44.69 | 42.30 | 42.16 | 41.68 | 15.83 |
| 6 | 48.02 | 51.08 | 49.58 | 47.13 | 46.23 | 45.49 | 47.18 | 6.37 |
| 7 | 55.69 | 54.72 | 53.02 | 52.96 | 51.16 | 54.2 | 54.7 | 5.94 |
| 8 | 54.14 | 49.13 | 43.49 | 40.09 | 35.63 | 37.75 | 35.78 | 34.19 |

*The day ESBR began to cross-link. An overall increase in Mooney viscosity is expected when degradation via crosslinking predominates over chain scission. Degradation of ESBR is dominated by crosslinking.

Elastomeric structures primarily degrade by two different mechanisms of degradation; chain scission and crosslinking. The act of chain scission generally takes place earlier on in the degradation process and can result in the lowering of Mooney viscosity. Cross linking generally occurs later in the process and results in an increase in Mooney viscosity. It is theorised that Example 8 Exhibits rather higher initial chain scission than other Examples, but subsequently exhibits relatively low fluctuation in Mooney viscosity, as witnessed between days 2 and 6, compared with the Comparative Examples.

The less fluctuation in Mooney viscosity values over time demonstrates the structural integrity of the elastomer and shows minimal degradation.

The Examples according to the invention show superior Mooney viscosity to the comparative examples at equivalent loading and are equivalent or superior to the comparative examples at lower loading level.

Therefore, the Examples which comprise the stabilising composition in accordance with the present invention clearly exhibit superior Mooney viscosity retention and outperform comparative Examples A to D. These stabilising compositions will have better storage stability capabilities with greater retention of physical properties.

The Examples according to the invention show a lower degree of fluctuation of Mooney viscosity between day 0 and day 6. As can be seen from the results, the maximum % fluctuation of the Examples according to the present invention are significantly lower that the comparative examples.

Therefore, the Examples which comprise the stabilising composition in accordance with the invention clearly display greater retention and less drift of Mooney viscosity and outperform comparative Examples A to D.

Samples of Examples 9 and 10 were taken for Mooney viscosity testing. Mooney viscosity values are measured using the standard method ASTM D1646 (1+4) T 100° C. Mooney viscosity values are taken at 0 hours and then at 12, 24, 36 and 72 hours.

Mooney Viscosity

| | 0 | 12 | 24 | 36 | 72 | Max % |
|---|---|---|---|---|---|---|
| Ex. | hours | hours | hours | hours | hours | Fluctuation |
| 9 | 57.2 | 56.2 | 55.0 | 55.5 | 57.6 | 3.89 |
| 10 | 56.3 | 56.5 | 55.8 | 56.4 | 56.8 | 0.89 |

Examples 9 and 10 both comprise the stabilising composition in accordance with the invention. Example 10 shows a considerably lower degree of fluctuation of Mooney viscosity between 0 and 72 hours.

As can be seen from the results, the addition of Component D to the stabilising composition significantly increases stabilisation and reduces fluctuation in Mooney viscosity. Therefore, the Example which comprises a 4-component stabilising composition in accordance with the invention (Example 10) clearly displays greater retention and less drift of Mooney viscosity. This stabilising composition will have better storage stability capabilities with greater retention of physical properties.

Elastomer converters typically standardise the processing conditions of elastomers for mass production, therefore a drift in Mooney viscosity will result in the fluctuation of final article properties and result in quality inconsistency. This is undesirable.

The accelerated heat aging test simulates changes in Mooney viscosity during various storage and transportation conditions. This gives elastomer producers an indication of how stabile their elastomer will be.

The increased stabilisation and reduced fluctuation in Mooney viscosity when using the stabilising compositions in accordance with the invention is therefore beneficial to the customer and results in greater consistency of product quality.

1. A stabilising composition for an elastomer, comprising:
a. at least one phosphite antioxidant;
b. at least one aminic antioxidant; and
c. at least one phenolic antioxidant.

2. (canceled)

3. The stabilising composition according to claim 1, further comprising at least one sulphur-containing antioxidant.

4. The stabilising composition according to claim 1, wherein the phenolic antioxidant is a hindered phenolic antioxidant.

5. The stabilising composition according to claim 1, wherein the phenolic antioxidant is present in the stabilising composition in an amount of from about 20% to about 50% by weight of the stabilising composition.

6. The stabilising composition according to claim 1, wherein the phosphite antioxidant is a triaryl phosphite or a nonyl phenyl free antioxidant.

7. The stabilising composition according to claim 1, wherein the phosphite antioxidant is present in an amount from about 45% to about 70% by weight of the stabilising composition.

8. The stabilising composition according to claim 1, wherein the phosphite antioxidant is a liquid at a temperature of 50° C. or lower, at atmospheric pressure i.e. 101.325 kPa.

9. The stabilising composition according to claim 1, wherein the aminic antioxidant is a secondary amine.

10. The stabilising composition according to claim 1, wherein the aminic antioxidant comprises at least one aromatic group.

11. The stabilising composition according to claim 1, wherein the aminic antioxidant is 4,4′-bis(α,α-dimethylbenzyl) diphenylamine and/or mixed butylated, octylated diphenyl amine.

12. The stabilising composition according to claim 1, wherein the aminic antioxidant is present in the stabilising composition in an amount of from about 5% to about 25% by weight of the stabilising composition.

13. The stabilising composition according to claim 1, wherein the ratio of phosphite antioxidant to aminic antioxidant to phenolic antioxidant is:
(from about 45 to about 65):(from about 5 to about 25):(from about 15 to about 30).

14. The stabilising composition according to claim 3, wherein the ratio of phosphite antioxidant to aminic antioxidant to phenolic antioxidant to sulphur-containing antioxidant in the stabilising composition is:
(from about 45 to about 65):(from about 5 to about 25):(from about 15 to about 30):(from about 1 to about 15).

15. The stabilising composition according to claim 1, wherein the stabilising composition is a liquid composition at a temperature of 50° C. or lower, at atmospheric pressure i.e. 101.325 kPa.

16-18. (canceled)

19. A stabilised elastomeric composition, comprising:
a. an elastomeric material; and
b. the stabilising composition according to claim 1.

20. The stabilised elastomeric composition according to claim 19
wherein the elastomeric material comprises a natural rubber and/or synthetic rubber; and/or
wherein the elastomeric material is a product of emulsion polymerisation.

21. The stabilised elastomeric composition according to claim 19 wherein the elastomeric material is a butadiene based elastomer.

22. The stabilised elastomeric composition according to claim 21, wherein the butadiene based elastomer is selected from the group consisting of styrene-butadiene, polybutadiene, nitrile rubber, polychloroprene, and mixtures thereof.

23. (canceled)

24. An article comprising the stabilised elastomeric composition of claim 19.

25. (canceled)

26. The stabilised elastomeric composition according to claim 19, wherein the Mooney viscosity of the elastomeric composition, measured in accordance with ASTM D1646, fluctuates less over a six day heat aging period at 100° C. than that of the same elastomeric composition containing an equivalent w/w amount of the same stabilising composition, absent any aminic component.

27. The stabilised elastomeric composition according to claim 19, wherein the Mooney viscosity of the elastomeric composition, measured in accordance with ASTM D1646, has a maximum % fluctuation of less than 25% over a six day period.

28. The stabilised elastomeric composition according to claim 19, wherein the elastomeric composition has a Yellowness Index value, measured in accordance with ASTM E313, to be less than 40, after a period of four days.
